(19) United States
(12) Patent Application Publication
(10) Pub. No.: US 2012/0167087 A1
(43) Pub. Date: Jun. 28, 2012

(54) APPARATUS AND METHOD FOR DRIVING VIRTUAL MACHINE, AND METHOD FOR DEDUPLICATION OF VIRTUAL MACHINE IMAGE

(75) Inventors: Joong-Soo LEE, Daejeon (KR); Song-Woo SOK, Daejeon (KR)

(73) Assignee: Electronics and Telecommunications Research Institute, Daejeon (KR)

(21) Appl. No.: 13/335,145

(22) Filed: Dec. 22, 2011

(30) Foreign Application Priority Data
Dec. 23, 2010 (KR) 10-2010-0133948

(51) Int. Cl. G06F 9/455

(52) U.S. Cl. 718/1

(57) ABSTRACT

Disclosed herein is a method for deduplication of virtual machine images, including: generating a plurality of chunks by dividing the virtual machine images into predetermined units; determining chunks corresponding to identifiers previously stored in a repository as chunks previously stored in the repository using identifiers for each of the plurality of chunks; storing chunks that have not been stored in the repository among the plurality of chunks in the repository using the chunks previously stored in the repository; and storing inner position information on each of the plurality of chunks for the virtual machine images in image specifications corresponding to the virtual machine images.

### CROSS-REFERENCE(S) TO RELATED APPLICATIONS

This application claims priority to Korean Patent Application No. 10-2010-0133948, filed on Dec. 23, 2010, which is incorporated herein by reference in its entirety.

### BACKGROUND OF THE INVENTION

1. Field of the Invention

The present invention relates to an apparatus and a method for driving a virtual machine and a method for deduplication of virtual machine images, and particularly, to an apparatus and a method for improving the driving speed of a virtual machine and a method for deduplication of virtual machine images.

2. Description of Related Art

Cloud computing is a computing model that permits users to use server resources at lower costs by providing an environment that can dynamically dispose and execute several virtual machines at each computer node while operating the plurality of computer nodes on a data center. In order to execute the virtual machine in a physical machine, a compressed file type of disk images, that is, virtual machine images, is required. The above-mentioned virtual machine image is recognized as a file in the physical machine, but is recognized as a disk in the virtual machine.

Since the contents of the virtual machine images change according to the operating system (OS), software, application data, and the like, the virtual machine images may occupy a very large space when each user stores different disk images.

The virtual machine images need to be copied to a hard disk of the physical machine that drives the virtual machine or loaded into memory. However, in the case in which a storage system in which the virtual machine images are stored is mounted through a network, the response speed may be slow when the virtual machine accesses the virtual machine images during operation.

Further, when the virtual machine images are copied to the physical machine that drives the virtual machine, it takes a long time to copy the virtual machine images to the physical machine, such that the time required to set up the virtual machine may be increased.

### SUMMARY OF THE INVENTION

An embodiment of the present invention is directed to an apparatus and a method for driving a virtual machine and a method for deduplication of virtual machine images so as to improve the driving speed of a virtual machine while reducing the time taken to copy disk images through a network when a user intends to use the virtual machine.

Other objects and advantages of the present invention can be understood by the following description, and will become apparent with reference to the embodiments of the present invention. Also, it will be obvious to those skilled in the art to which the present invention pertains that the objects and advantages of the present invention can be realized by the means as claimed and combinations thereof.

In accordance with an embodiment of the present invention, a method for deduplication of virtual machine images includes: generating a plurality of chunks by dividing the virtual machine images into predetermined units; determining chunks corresponding to identifiers previously stored in a repository as chunks that were previously stored in the repository by using identifiers for each of the plurality of chunks; storing chunks that are not stored in the repository among the plurality of chunks in the repository by using the chunks previously stored in the repository; and storing inner positional information on each of the plurality of chunks for the virtual machine images in image specifications corresponding to the virtual machine images.

In accordance with another embodiment of the present invention, a method for driving a virtual machine includes: copying the chunks of which the frequency of use exceeds a reference value among a plurality of chunks stored in a repository to an apparatus using a plurality of identifiers stored in the repository; configuring virtual machine images using the copied chunks; and driving a virtual machine using the virtual machine images.

An apparatus for driving a virtual machine in accordance with another embodiment of the present invention includes a local chunk storage unit, a local key storage unit, an image specification storage unit, and a virtual machine driving unit. The local chunk storage unit stores the local chunks of which the frequency of use is a reference value or higher among the plurality of chunks stored in the repository. The local key storage unit stores local identifiers including information about the storage location of the local chunks. The image specification storage unit stores an image specification including inner positional information and local identifiers for the local chunks used for the virtual machine images. The virtual machine driving unit extracts the local chunks from the local chunk storage unit by using information about the storage location of the local chunks including the local identifiers, configures the virtual machine images included in the local chunks using the inner positional information on the local chunks, and drives a virtual machine using the virtual machine images.

### BRIEF DESCRIPTION OF THE DRAWINGS

FIG. 1 is a diagram illustrating the configuration of a system for deduplication of virtual machine images in accordance with an exemplary embodiment of the present invention;

FIG. 2 is a diagram illustrating a method for deduplication of virtual machine images in accordance with the exemplary embodiment of the present invention;

FIG. 3 is a diagram illustrating a method for storing chunks in accordance with the exemplary embodiment of the present invention;

FIG. 4 is a diagram illustrating a method for driving a virtual machine in accordance with the exemplary embodiment of the present invention; and

FIG. 5 is a diagram illustrating a method for storing local chunks in accordance with the exemplary embodiment of the present invention.

### DESCRIPTION OF SPECIFIC EMBODIMENTS

Exemplary embodiments of the present invention will be described below in greater detail with reference to the accompanying drawings. The present invention may, however, be embodied in different forms and should not be construed as being limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

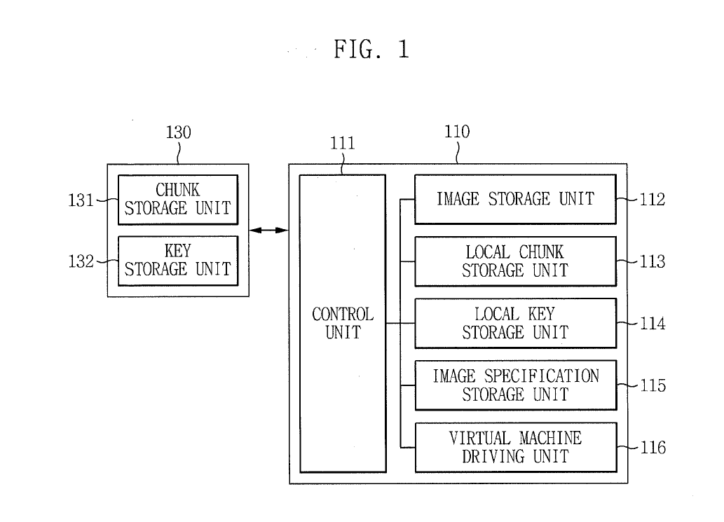

First, a system for deduplication of virtual machine images in accordance with an exemplary embodiment of the present invention will be described with reference to FIG. 1.

FIG. 1 is a diagram illustrating the configuration of a system for deduplication of virtual machine images in accordance with an exemplary embodiment of the present invention.

As illustrated in FIG. 1, the system for deduplication of virtual machine images includes a physical machine 110 and an image repository 130, wherein the physical machine 110 and the image repository 130 are connected to each other through a network interface, such as an Ethernet interface.

The image repository 130, which is at least one computer system having at least one hard disk mounted thereto, includes a chunk storage unit 131 and a key storage unit 132.

The chunk storage unit 131 stores chunks in predetermined units.

The key storage unit 132 stores identifiers corresponding to the chunks stored in the chunk storage unit 131.

The physical machine 110, which is a single computer system, includes a control unit 111, an image storage unit 112, a local chunk storage unit 113, a local key storage unit 114, an image specification storage unit 115, and a virtual machine driving unit 116.

The control unit 111 stores the virtual machine images in the image repository 130 in the predetermined chunk units, stores frequently used chunks among the plurality of chunks stored in the image repository 130 in the local chunk storage unit 113, and provides the chunks stored in the chunk storage unit 131 in the image repository 130 or the local chunk storage unit 113 to the virtual machine driving unit 116 by using the image specifications stored in the image specification storage unit 115.

The image storage unit 112 stores the virtual machine image.

The local chunk storage unit 113 stores frequently used chunks among the plurality of chunks stored in the image repository 130.

The local key storage unit 114 stores identifiers corresponding to the chunks stored in the local chunk storage unit 113.

The image specification storage unit 115 stores image specifications including identifiers for the chunks used for the virtual machine images, the size of the corresponding chunks, and positions within the virtual machine images of the corresponding chunks.

The virtual machine driving unit 116 configures the virtual machine images using the chunks stored in the chunk storage unit 131 in the image repository 130 or the local chunk storage unit 113 and drives the virtual machine using the virtual machine images.

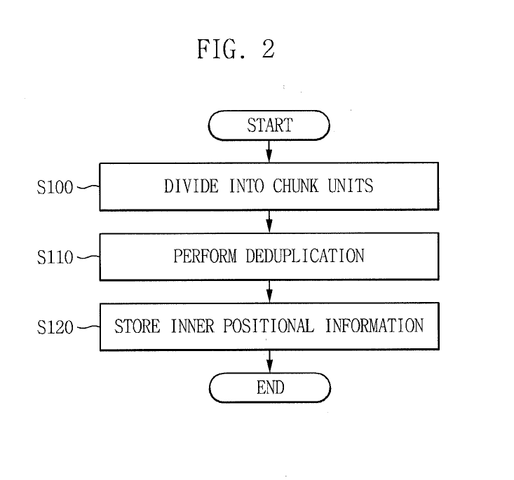

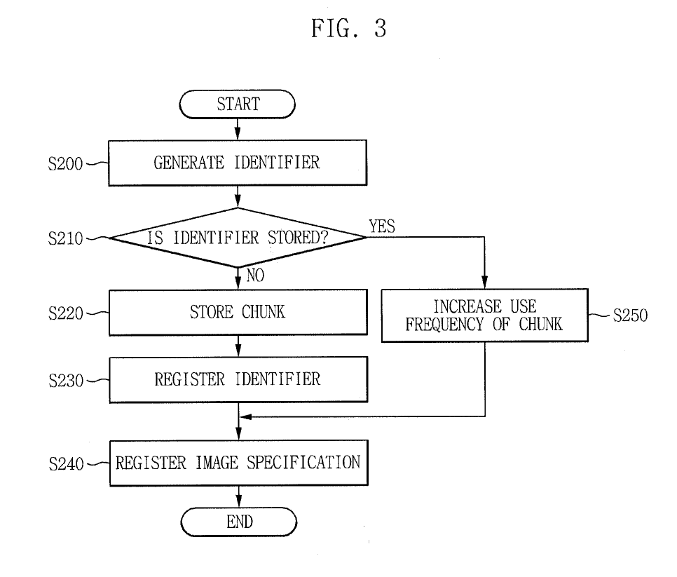

Next, a method for deduplication of virtual machine images in accordance with the exemplary embodiment of the present invention will be described with reference to FIGS. 2 and 3.

FIG. 2 is a diagram illustrating a method for deduplication of virtual machine images in accordance with the exemplary embodiment of the present invention.

As illustrated in FIG. 2, first, the control unit 111 divides the virtual machine images stored in the image storage unit 112 into predetermined chunk units to generate the plurality of chunks (S100).

Next, the control unit 111 performs the removal of duplicates from among the plurality of chunks in order to store the plurality of chunks in the chunk storage unit 131 in the image repository 130 (S110).

Thereafter, the control unit 111 stores the inner positional information on each of the plurality of chunks for the virtual machine image in the image specifications corresponding to the virtual machine image (S120).

FIG. 3 is a diagram illustrating a method for storing chunks in accordance with the exemplary embodiment of the present invention.

As illustrated in FIG. 3, first, the control unit 111 applies an object chunk corresponding to any one of the plurality of chunks included in the virtual machine images to a hash function to generate an identifier for the object chunk (S200).

Next, the control unit 111 determines whether the generated identifier is already stored in the key storage unit 132 in the image repository 130 (S210).

As the determination result at S210, if it is determined that the identifier is not stored, the control unit 111 stores the object chunk in the chunk storage unit 131 in the image repository 130 (S220).

Next, the control unit 111 registers the identifiers in the key storage unit 132 in the image repository 130 (S230). In this case, the identifier includes the storage position and the frequency of use of the object chunk.

Then, the control unit 111 registers the identifier for the object chunk and the position and size of the object chunk in the virtual machine image in the image specification of the virtual machine image (S240).

As the determination result at S210, when the identifier is stored, the control unit 111 increases the frequency of use of the chunk included in the identifier (S250). In this case, the identifier includes the storage position and the frequency of use of the object chunk.

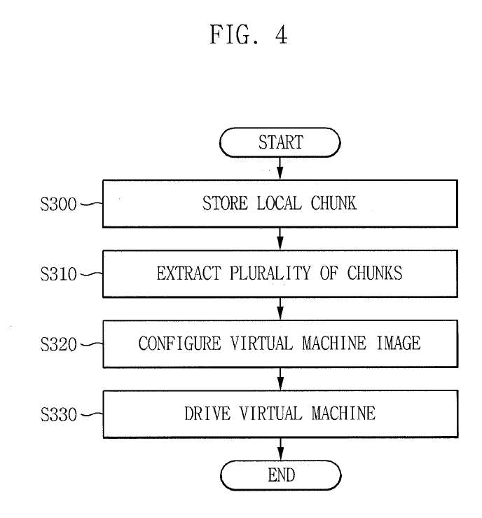

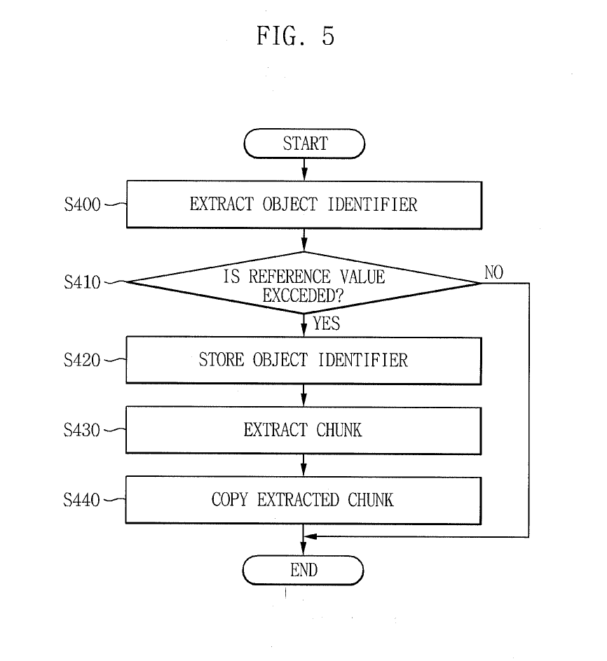

Next, a method for driving a virtual machine by a physical machine in accordance with the exemplary embodiment of the present invention will be described with reference to FIGS. 4 and 5.

FIG. 4 is a diagram illustrating a method for driving a virtual machine in accordance with the exemplary embodiment of the present invention.

As illustrated in FIG. 4, the control unit 111 uses the frequency of use of the chunk of each of the plurality of identifiers registered in the key storage unit 132 in the image repository 130 to store the local chunk corresponding to the chunk corresponding to the identifier of which the frequency of use of the chunk exceeds a predetermined reference value in the local chunk storage unit 113 (S300). In this case, the local chunk corresponds to the chunk having the highest frequency of use among the plurality of chunks stored in the chunk storage unit 131 of the image repository 130.

Next, the control unit 111 uses the image specifications of the virtual machine images stored in the image specification storage unit 115 so as to drive the virtual machine to extract the plurality of chunks used for the virtual machine images from the chunk storage unit 131 in the image repository 130 or the local chunk storage unit 113 (S310).

Then, the control unit 111 uses the plurality of extracted chunks to configure the virtual machine image (S320). In this case, the control unit 111 may store the configured virtual machine images in the image storage unit 112.

Next, the virtual machine driving unit 116 uses the configured virtual machine images to drive the virtual machine (S330).

FIG. 5 is a diagram illustrating a method for storing local chunks in accordance with the exemplary embodiment of the present invention.

As illustrated in FIG. 5, first, the control unit 111 extracts an object identifier corresponding to any one of the plurality of identifiers registered in the key storage unit 132 in the image repository 130 (S400).

Next, the control unit 111 compares the frequency of use of the chunk included in the object identifier with the predetermined reference value to determine whether the frequency of use of the chunk exceeds the reference value (S410).

As the determination result at S410, when the frequency of use of the chunk exceeds the reference value, the control unit 111 stores the object identifier in the local key storage unit 114 (S420).

Then, the control unit 111 uses the storage position of the chunk included in the object identifier to extract the chunk corresponding to the object identifier from the chunk storage unit 131 in the image repository 130 (S430).

Next, the control unit 111 copies the extracted chunk to the local chunk storage unit 113 (S440).

Through this configuration, the physical machine 110 stores frequently used chunks among the plurality of chunks stored in the chunk storage unit 131 in the image repository 130 in advance so as to improve the driving speed of the virtual machine by using the identifiers and the chunks stored in the physical machine 110 when the virtual machine images are copied to the physical machine 110 or mounted through the network.

In accordance with the exemplary embodiments of the present invention, the copy speed can be reduced by copying the virtual machine images to the physical machine, thereby reducing time required to set up the virtual machine as experienced by the user. Further, many portions of the virtual machine images can be read in the local area without having to establish a network connection every time the virtual machine accesses the hard disk, when the virtual machine images are mounted through the network, thereby improving the driving speed of the services or the applications performed in the virtual machine and storing in advance the chunks that are highly likely to be commonly used in the virtual machine.

While the present invention has been described with respect to specific embodiments thereof, it will be apparent to those skilled in the art that various changes and modifications may be made Without departing from the spirit and scope of the invention as defined in the following claims.

What is claimed is:

1. A method for deduplication of virtual machine images, comprising:
generating a plurality of chunks by dividing the virtual machine images according to a predetermined unit;
determining chunks corresponding to identifiers that are previously stored in a repository as chunks that are previously stored in the repository using identifiers for each of the plurality of chunks;
storing chunks that are not stored in the repository among the plurality of chunks in the repository using the chunks previously stored in the repository; and
storing inner positional information on each of the plurality of chunks for the virtual machine images in image specifications corresponding to the virtual machine images.

2. The method as set forth in claim 1, wherein the storing the chunks in the repository includes:
generating object identifiers corresponding to object chunks among the plurality of chunks;
determining whether the object chunks are stored in the repository using the object identifiers; and
storing the object chunks in the repository when the object chunks are not stored in the repository.

3. The method as set forth in claim 2, wherein the storing the chunks in the repository includes:
determining whether the object identifiers are stored in the repository; and
storing the object chunks in the repository when the object identifiers are not stored in the repository.

4. The method as set forth in claim 3, wherein the storing the chunks in the repository further includes increasing a frequency of use of the chunks when the object identifiers are stored in the repository.

5. The method as set forth in claim 2, wherein the storing the chunks in the repository further includes registering the object identifiers, including storage positional information on the object chunks for the repository, in the repository.

6. The method as set forth in claim 5, wherein the storing the inner positional information in the image specifications stores the object identifiers corresponding to the inner positional information on the object chunk in the image specifications.

7. The method as set forth in claim 2, wherein the generating the object identifiers includes generating the object identifiers by applying the object chunks to a hash function.

8. A method for driving a virtual machine, comprising:
copying chunks of which a frequency of use exceeds a reference value among a plurality of chunks stored in a repository to an apparatus using a plurality of identifiers stored in a repository;
configuring virtual machine images using the copied chunks; and
driving a virtual machine using the virtual machine images.

9. The method as set forth in claim 8, wherein the copying the chunks includes:
determining whether the frequency of use of the chunks included in object identifiers among the plurality of identifiers exceeds the reference value; and
copying local chunks corresponding to the object identifiers to the apparatus when the frequency of use of the chunks exceeds the reference value.

10. The method as set forth in claim 9, wherein the copying the chunks further includes:
copying the object identifiers to the apparatus when the frequency of use of the chunks exceeds the reference value; and
copying the local chunks stored in the repository to the apparatus using a chunk storage position included in the object identifiers.

11. An apparatus for driving a virtual machine, comprising:
a local chunk storage unit configured to store a local chunk of which a frequency of use is a reference value or more among a plurality of chunks stored in a repository;
a local key storage unit configured to store local identifiers including storage positional information on local chunks;
an image specification storage unit configured to store image specifications including inner positional information and the local identifiers on the local chunks used for virtual machine images; and
a virtual machine driving unit configured to extract the local chunks from the local chunk storage unit using storage positional information on the local chunks included in the local identifiers, configure the virtual machine images including the local chunks using the inner positional information on the local chunks, and drive a virtual machine by using the virtual machine images.

12. The apparatus as set forth in claim 11, wherein the virtual machine driving unit configures the virtual machine images including a portion of the plurality of chunks stored in the repository.
